(19) United States
(12) Patent Application Publication
(10) Pub. No.: US 2024/0152726 A1
(43) Pub. Date: May 9, 2024

(54) SINGLE SEARCH FOR ARCHITECTURES ON EMBEDDED DEVICES

(71) Applicant: QUALCOMM Incorporated, San Diego, CA (US)

(72) Inventors: Chen FENG, Richmond Hill (CA); Xiaopeng ZHANG, Toronto (CA); Shaojie ZHUO, Richmond Hill (CA); Ramchalam KINATTINKARA RAMAKRISHNAN, North York (CA); Chenzheng SU, Toronto (CA); Liang SHEN, Toronto (CA); Zi Wen HAN, Calgary (CA); Yicheng LIN, Markham (CA)

(21) Appl. No.: 18/363,487

(22) Filed: Aug. 1, 2023

Related U.S. Application Data
(60) Provisional application No. 63/420,511, filed on Oct. 28, 2022.

(51) Int. Cl. G06N 3/04; G06N 3/084

(52) U.S. Cl. CPC G06N 3/04; G06N 3/084

(57) ABSTRACT

A processor-implemented method for a neural architecture search (NAS) starts by generating an over-parameterized super network having multiple layers. The super network has multiple operator types. Each of the layers includes a largest super kernel corresponding to a search space. The method also includes performing gradient descent to evolve a largest super kernel to a small kernel corresponding to the search space in order to generate a range of kernel encodings. The method further includes identifying a subset of kernel encodings from the range of kernel encodings, for each layer of the super network, based on the gradient descent. The method determines a set of candidate architectures based on the subset of kernel encodings, each of the candidate architectures having a different model size. The method selects a target model, from the set of architectures, based on meeting hardware specifications, and then applies the target model.

### CROSS-REFERENCE TO RELATED APPLICATION

The present application claims the benefit of U.S. Provisional Patent Application No. 63/420,511, filed on Oct. 28, 2022, and titled “SINGLE SEARCH FOR ARCHITECTURES ON EMBEDDED DEVICES,” the disclosure of which is expressly incorporated by reference in its entirety.

### FIELD OF THE DISCLOSURE

Aspects of the present disclosure generally relate to neural network architecture searching, and more specifically to a one-shot neural architecture search (NAS) for hardware efficient architectures to run on devices with limited resources.

### BACKGROUND

Artificial neural networks may comprise interconnected groups of artificial neurons (e.g., neuron models). The artificial neural network may be a computational device or be represented as a method to be performed by a computational device. Convolutional neural networks (CNNs) are a type of feed-forward artificial neural network. Convolutional neural networks may include collections of neurons that each have a receptive field and that collectively tile an input space. Convolutional neural networks, such as deep convolutional neural networks (DCNs), have numerous applications. Other types of neural networks include recurrent neural networks multilevel perceptrons (MLPs) and transformers, among others. These neural network architectures are used in various technologies, such as image recognition, speech recognition, acoustic scene classification, keyword spotting, autonomous driving, and other classification tasks.

Deploying a high level neural network on embedded devices is difficult yet important for the widespread use of deep learning. Existing neural architecture search and compression algorithms may be computationally expensive, heavily targeted at convolutional neural networks, or mismatch with hardware behavior.

### SUMMARY

A processor-implemented method for a neural architecture search (NAS) starts by generating an over-parameterized super network having multiple layers. The super network has multiple operator types. Each of the layers includes a largest super kernel corresponding to a search space. The method also includes performing gradient descent to evolve a largest super kernel to a small kernel corresponding to the search space in order to generate a range of kernel encodings. The method further includes identifying a subset of kernel encodings from the range of kernel encodings, for each layer of the super network, based on the gradient descent. The method determines a set of candidate architectures based on the subset of kernel encodings, each of the candidate architectures having a different model size. The method selects a target model, from the set of architectures, based on meeting hardware specifications, and then applies the target model.

Other aspects of the present disclosure are directed to an apparatus. The apparatus has a memory and one or more processors coupled to the memory. The processor(s) is configured to generate an over-parameterized super network having a number of layers. The super network comprises a number of operator types. Each layer of the number of layers comprises a largest super kernel corresponding to a search space. The processor(s) is also configured to perform gradient descent to evolve a largest super kernel to a small kernel corresponding to the search space to generate a range of kernel encodings. The processor(s) is further configured to identify a subset of kernel encodings from the range of kernel encodings, for each layer of the super network, based on the gradient descent. The processor(s) is also configured to determine a set of candidate architectures based on the subset of kernel encodings. Each candidate architecture of the set of candidate architectures has a different model size. The processor(s) is also configured to select a target model, from the set of architectures, based on meeting hardware specifications. The processor(s) is also configured to apply the target model.

Other aspects of the present disclosure are directed to an apparatus. The apparatus includes means for generating an over-parameterized super network having a number of layers. The super network comprises a number of operator types. Each layer of the number of layers comprises a largest super kernel corresponding to a search space. The apparatus also includes means for performing gradient descent to evolve a largest super kernel to a small kernel corresponding to the search space to generate a range of kernel encodings. The apparatus further includes means for identifying a subset of kernel encodings from the range of kernel encodings, for each layer of the super network, based on the gradient descent. The apparatus also includes means for determining a set of candidate architectures based on the subset of kernel encodings. Each candidate architecture of the set of candidate architectures has a different model size. The apparatus also includes means for selecting a target model, from the set of architectures, based on meeting hardware specifications. The apparatus also includes means for applying the target model.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a neural network using a system-on-a-chip (SOC), including a general-purpose processor in accordance with certain aspects of the present disclosure.

FIGS. 2A, 2B, and 2C are diagrams illustrating a neural network in accordance with various aspects of the present disclosure.

FIG. 2D is a diagram illustrating an exemplary deep convolutional network (DCN) in accordance with various aspects of the present disclosure.

FIG. 3 is a block diagram illustrating an exemplary deep convolutional network (DCN) in accordance with various aspects of the present disclosure.

FIG. 4 is diagram illustrating an overall workflow for neural network architecture searching, in accordance with various aspects of the present disclosure.

FIG. 5 is a diagram illustrating a heterogeneous operator level search space, in accordance with various aspects of the present disclosure.

FIG. 6 is diagram illustrating node splitting with an architecture co-design, in accordance with various aspects of the present disclosure.

FIG. 7 is diagram illustrating weight sharing techniques in a super kernel, in accordance with various aspects of the present disclosure.

FIG. 8 is a diagram illustrating progressive growing, in accordance with various aspects of the present disclosure.

FIG. 9 is a diagram illustrating progressive shrinking, in accordance with various aspects of the present disclosure.

FIG. 10 is a block diagram illustrating knowledge distillation in a neural architecture search (NAS), in accordance with various aspects of the present disclosure.

FIG. 11 is a flow diagram illustrating an example processor-implemented method of searching neural network architectures, in accordance with various aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks, and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Deploying a high level neural network on embedded devices is difficult yet important for the widespread use of deep learning. Existing neural architecture search and compression algorithms may be computationally expensive, heavily targeted at convolutional neural networks, or mismatch with hardware behavior.

Aspects of the present disclosure propose a fast neural architecture search process, referred to as one search for all (OSFA), to create a set of common network architectures on low resource hardware platforms. The new search process leverages weight sharing to search for convolution, recurrent, multilayer perceptron (MPL), or transformer architectures for execution on low resource platforms. Network accuracy, runtime latency, and peak memory usage are jointly optimized for hardware efficiency. With the new search process, accuracy is maintained or exceeded compared to a baseline model, enabling an inexpensive general adaptation of neural networks to low resource platforms. The new search process decreases the search cost in terms of graphics processing unit (GPU) hours needed to find a good architecture.

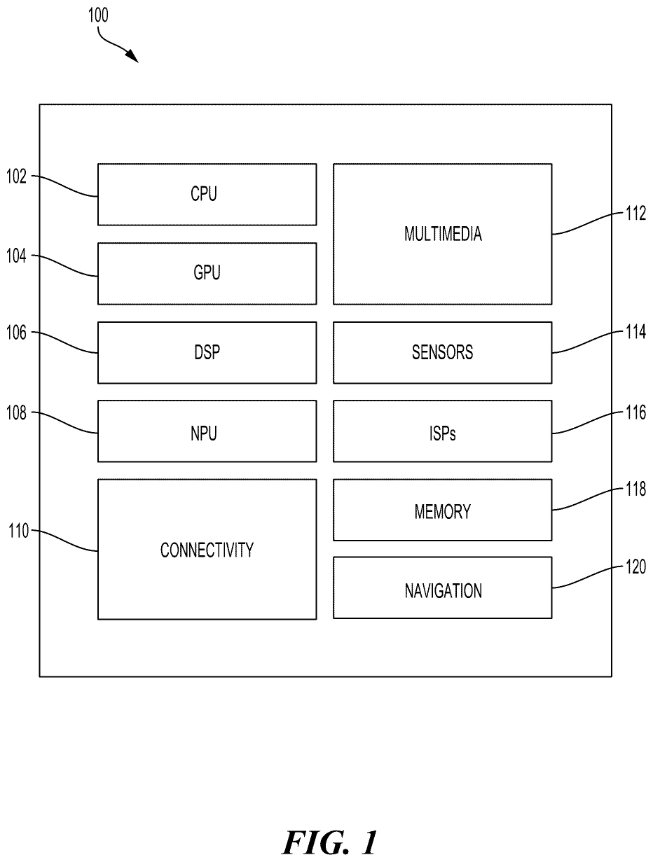

FIG. 1 illustrates an example implementation of a system-on-a-chip (SOC) 100, which may include a central processing unit (CPU) 102 or a multi-core CPU configured for neural architecture searching. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM instruction set. In an aspect of the present disclosure, the instructions loaded into the general-purpose processor 102 may include code to generate an over-parameterized super network having multiple layers. The super network has multiple operator types. Each of the layers includes a largest super kernel corresponding to a search space. The general-purpose processor 102 may also include code to perform gradient descent to evolve a largest super kernel to a small kernel corresponding to the search space in order to generate a range of kernel encodings. The general-purpose processor 102 may include code to identify a subset of kernel encodings from the range of kernel encodings, for each layer of the super network, based on the gradient descent. The general-purpose processor 102 may further include code to determine a set of candidate architectures based on the subset of kernel encodings, each of the candidate architectures having a different model size. The general-purpose processor 102 may include code to select a target model, from the set of architectures, based on meeting hardware specifications, and then apply the target model.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

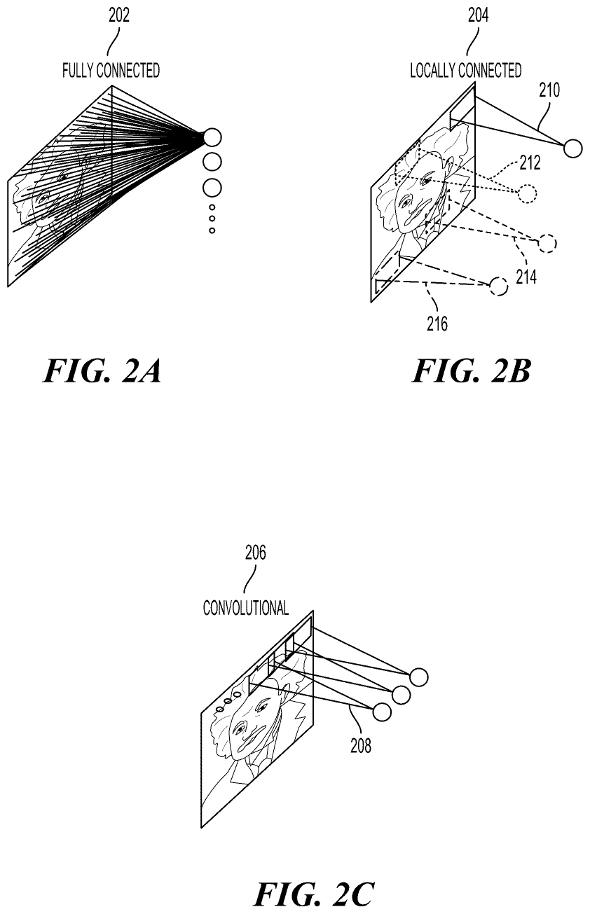

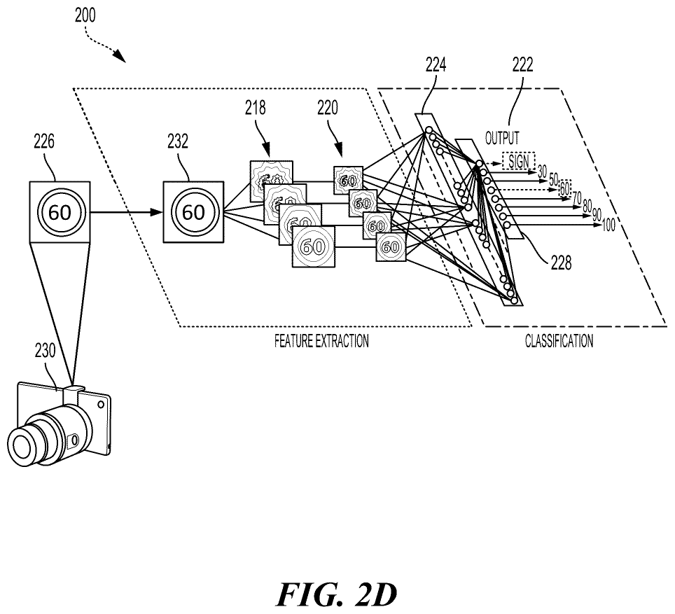

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

One type of convolutional neural network is a deep convolutional network (DCN). FIG. 2D illustrates a detailed example of a DCN 200 designed to recognize visual features from an image 226 input from an image capturing device 230, such as a car-mounted camera. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 may be a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 may likely be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN 200 may be presented with new images (e.g., the speed limit sign of the image 226) and a forward pass through the DCN 200 may yield an output 222 that may be considered an inference or a prediction of the DCN 200.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

DCNs are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 220) receiving input from a range of neurons in the previous layer (e.g., feature maps 218) and from each of the multiple channels. The values in the feature map may be further processed with a non-linearity, such as a rectification, max(0, x). Values from adjacent neurons may be further pooled, which corresponds to down sampling, and may provide additional local invariance and dimensionality reduction. Normalization, which corresponds to whitening, may also be applied through lateral inhibition between neurons in the feature map.

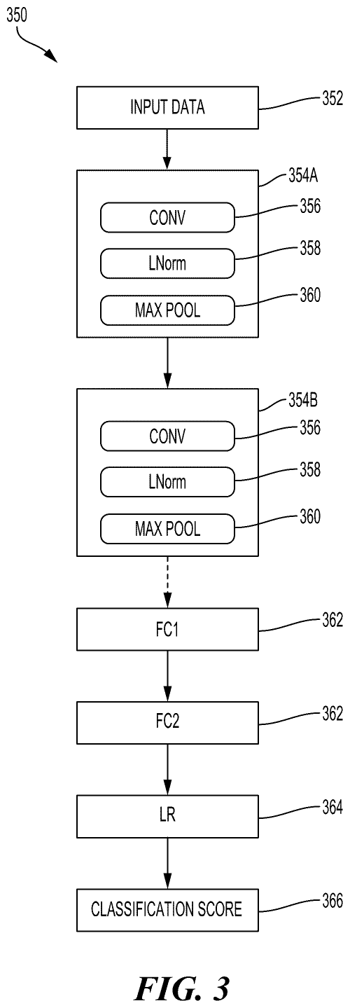

FIG. 3 is a block diagram illustrating a DCN 350. The DCN 350 may include multiple different types of layers based on connectivity and weight sharing. As shown in FIG. 3, the DCN 350 includes the convolution blocks 354A, 354B. Each of the convolution blocks 354A, 354B may be configured with a convolutional layer (CONV) 356, a normalization layer (LNorm) 358, and a max pooling layer (MAX POOL) 360.

Although only two of the convolution blocks 354A, 354B are shown, the present disclosure is not so limiting, and instead, any number of the convolution blocks 354A, 354B may be included in the DCN 350 according to design preference.

The convolutional layers 356 may include one or more convolutional filters, which may be applied to the input data to generate a feature map. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

The parallel filter banks, for example, of a deep convolutional network may be loaded on a CPU 102 or GPU 104 of an SOC 100 (e.g., FIG. 1) to achieve high performance and low power consumption. In alternative embodiments, the parallel filter banks may be loaded on the DSP 106 or an ISP 116 of an SOC 100. In addition, the DCN 350 may access other processing blocks that may be present on the SOC 100, such as sensor processor 114 and navigation module 120, dedicated, respectively, to sensors and navigation.

The DCN 350 may also include one or more fully connected layers 362 (FC1 and FC2). The DCN 350 may further include a logistic regression (LR) layer 364. Between each layer 356, 358, 360, 362, 364 of the DCN 350 are weights (not shown) that are to be updated. The output of each of the layers (e.g., 356, 358, 360, 362, 364) may serve as an input of a succeeding one of the layers (e.g., 356, 358, 360, 362, 364) in the DCN 350 to learn hierarchical feature representations from input data 352 (e.g., images, audio, video, sensor data and/or other input data) supplied at the first of the convolution blocks 354A. The output of the DCN 350 is a classification score 366 for the input data 352. The classification score 366 may be a set of probabilities, where each probability is the probability of the input data including a feature from a set of features.

Deploying a high level neural network on embedded devices is difficult yet important for the widespread use of deep learning. Existing neural network architecture search and compression algorithms may be computationally expensive, heavily targeted at convolutional neural networks, or may mismatch with hardware behavior.

Aspects of the present disclosure propose a fast neural network architecture search process, referred to as one search for all (OSFA), to create a set of common network architectures for low resource hardware platforms. The new search process leverages weight sharing to search for convolution, recurrent, multilayer perceptron (MLP), or transformer architectures for execution on low resource platforms. Network accuracy, runtime latency, and peak memory usage are jointly optimized for hardware efficiency. With the new search process, accuracy is maintained or exceeded compared to a baseline model, enabling an inexpensive general adaptation of neural networks to low resource platforms.

Neural architecture search (NAS) has revolutionized the design of networks, leading to state-of-the-art (SOTA) performance for target use cases. By widely exploring the search space with sampling techniques, such as reinforcement learning and evolutionary search, these techniques seek to find a superior neural architecture by paying a tremendous search cost. To reduce the search cost, a family of NAS techniques, known as one-shot differentiable NAS, seeks to reduce this search cost by training a single over-parameterized super network that encodes all possible architectures in the search space.

In tandem, there is an increasing demand to deploy neural networks on embedded hardware platforms without relying on centralized computing. These platforms have specific hard resource constraints such as model memory, peak memory, bandwidth, and power consumption, along with an expectation of reasonable inference latency. This need for deployment on unique target platforms presents a challenge, as NAS processing would need to be rerun for each platform. An existing Once-For-All NAS technique addresses this problem by selecting sub-networks from a well-trained “once-for-all” (OFA) network, but the higher cost evolutionary search is used. There is little work on searching for a set of hardware-efficient architectures using the more efficient one-shot differentiable NAS family with weight sharing, especially when base architectures extend beyond convolution nets for tasks such as recurrent neural networks (RNNs) for keyword spotting.

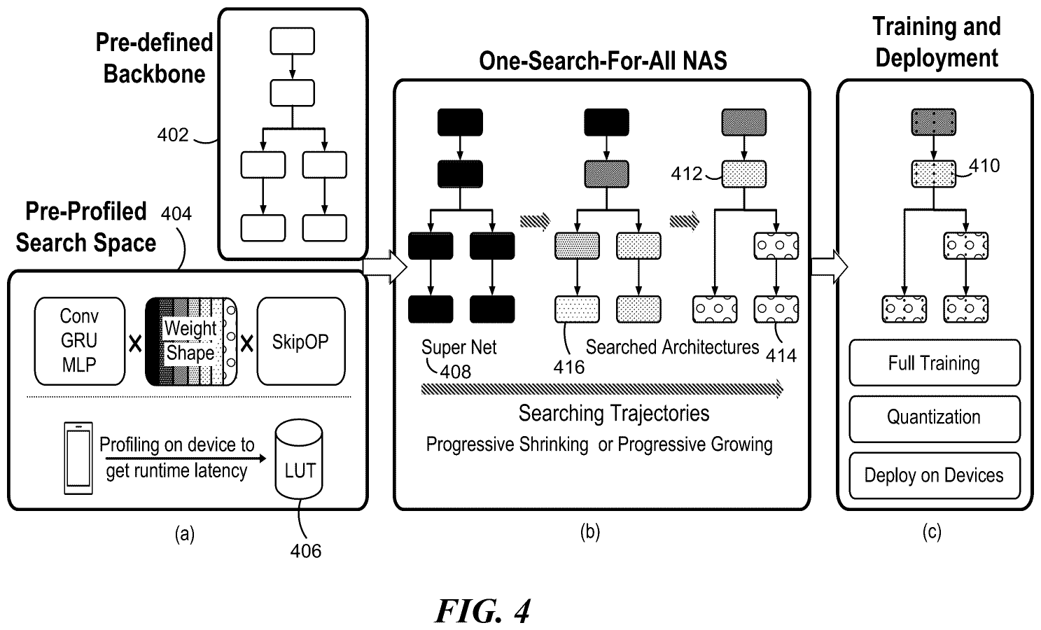

To tackle this disconnect, aspects of the present disclosure introduce one search for all (OSFA) NAS, a one-shot differentiable NAS technique for designing a set of neural network architectures for embedded platforms in only a few graphics processing unit (GPU) hours. Leveraging a weight sharing mechanism, OSFA can search for convolution, recurrent, and multilayer perceptron (MLP) network architectures on low resource platforms. Network accuracy, runtime latency, and peak memory usage are jointly optimized for hardware efficiency. An example of the overall workflow of OSFA is shown in FIG. 4.

FIG. 4 is diagram illustrating an overall workflow for neural network architecture searching, in accordance with various aspects of the present disclosure. In the example of FIG. 4, in the leftmost section (a) before a neural architecture search (NAS), a pre-defined backbone 402 is converted into a super kernel parameterization, in which all searchable operator configurations are profiled on-device for real metrics. The pre-defined backbone 402 is an input for the NAS. During the OSFA search, a lookup table (LUT) 406 is used for fast estimation of hardware-aware loss. A search space 404 is defined for different network types (e.g., convolutional (Conv), gated recurrent unit (GRU), and multilevel perceptron (MLP)). A skip operation (SkipOP) process, shown in the leftmost section (a) will be described later. Once a network architecture is selected (see rightmost section (c)), the selected network architecture is fully trained and deployed for downstream tasks.

An over-parameterized super network 408 with all possible architecture candidates is constructed. Only the largest super kernel per layer need be constructed to encode all candidate choices in a search space 404, allowing different candidate choices in each layer to share super kernel weights. The NAS problem is solved by finding which subset of kernel weights to use in each layer. To this end, two different search strategies: progressive growing and progressive shrinking, may be employed to encode architecture decisions during the search, as seen in the middle section (b). In the middle section (b), the different pattern types represent different configurations. For example, the pattern in the super network 408 may represent a 7×7 configuration, whereas blocks 412 and 414 may represent 5×5 and 3×3 configurations, respectively, and the pattern in block 416 may represent a long short-term memory (LSTM) layer. Instead of targeting only one final architecture, the super network 408 is guided to evolve from the largest super kernel encoding to the smallest through gradient descent. A set of network architecture decisions are made along the search trajectory, resulting in many different architectures with various model sizes. Finally, a target model 410 that fits the hardware requirements is sampled for full training, as shown in the rightmost section (c). The target model 410 is then quantized and deployed on the target device.

An additional challenge of deploying searched models on small hardware devices with a tight memory budget arises when memory usage from large activation tensors become a bottleneck. For example, a model with 2.3 million parameters may require a peak memory usage of more than 4.8 MB. To solve this problem, convolution node activations can be split into multiple tiles to reduce the peak memory usage during runtime, given depth-first scheduling. Manually designing the node split layer-by-layer and case-by-case is inefficient and difficult. Therefore, aspects of the present disclosure further augment the one-shot differentiable NAS search space to automate the process of node splitting. This architecture co-design significantly reduces peak memory usage and allows models to be deployed on small hardware devices without the need for activation bottlenecks.

Aspects of the present disclosure relate to a common one-shot differentiable NAS algorithm with super kernel weight sharing for convolutional, recurrent, MLP, and transformer architectures. Moreover, progressive growing and shrinking search strategies are introduced to discover a set of hardware-efficient architectures within a few GPU hours. Augmentation of the search space with activation tensor splitting fit large, otherwise irreducible intermediate outputs, within tight peak memory constraints on embedded devices.

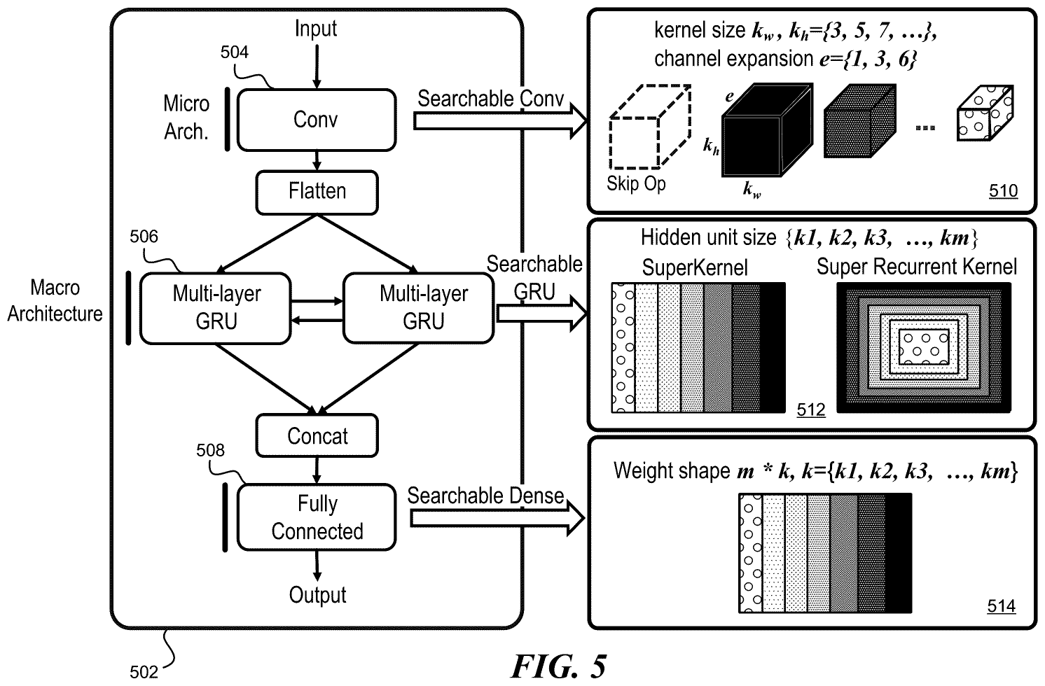

For the search space, a macro-architecture backbone is given as a starting point. The backbone is composed of many different layers, such as convolutions, depthwise separable convolutions, RNNs, and fully connected layers. As illustrated in FIG. 5, the search space is predefined for each operation type. By doing so, only the micro-architecture within each layer is searched.

FIG. 5 is a diagram illustrating a heterogeneous operator level search space, in accordance with various aspects of the present disclosure. In the example of FIG. 5, a macro architecture 502 includes convolutional layers 504, GRUs 506, and fully connected layers 508. For convolutional layers 504, an expansion ratio and kernel size are searched. For ring-based GRUs 506 and column-based fully connected layers 508, hidden unit sizes are searched. An example of the heterogeneous operator level search space of OSFA with convolutional, GRU, and fully connected layers will now be described.

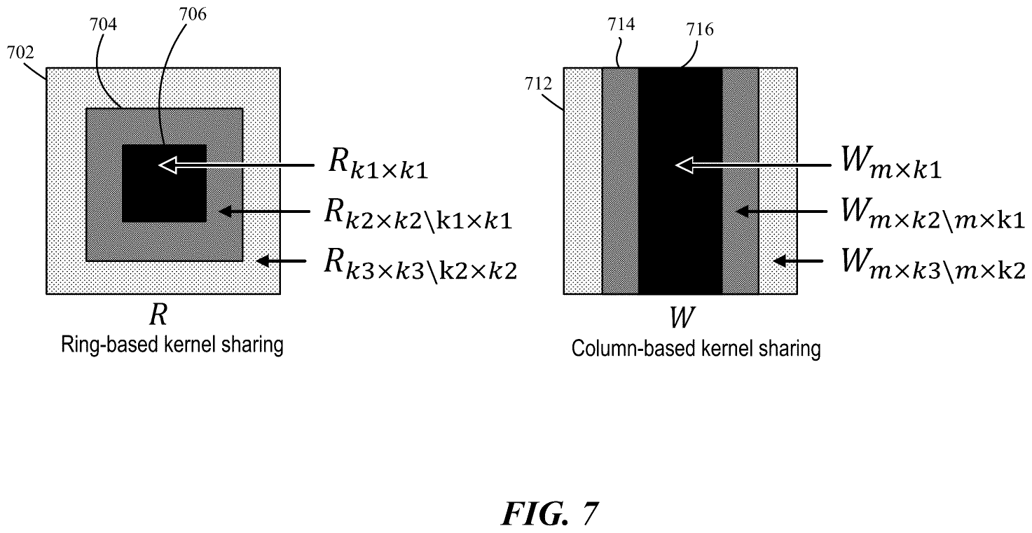

As seen in section 510, the convolutional layers 504 may be parameterized by kₕ×k_{w}, i, n, representing the spatial filter size (height and width), input channels, and output channels, respectively. If the baseline architecture uses a square kernel, let kₕ=k_{w}=k. For mobile inverted bottleneck (MIB) blocks and depthwise separable convolutions, the search is conducted over the inverted bottleneck expansion ratio e instead of the number of output channels, which are fixed. The skip operation indicates which channels can be skipped, when a number of channels is defined. More detail of kernel sharing will be described with respect to FIG. 7.

As seen in section 512, RNN layers (corresponding to the GRUs 506) may be parameterized by the input feature size, m, and the hidden unit size for the kernel/recurrent kernel, k. The search is performed over the hidden unit size for the kernel/recurrent kernel, k. For bi-directional layers with multiple gates, forward kernels fᵢ and backward kernels bᵢ, are searched for each gate i. The different patterns seen in section 512 for the super kernel and super recurrent kernel represent how weights are shared for the GRUs 506 and are described in more detail with respect to FIG. 7.

As seen in section 514, MLP layers (corresponding to the fully connected layers 508) may be parameterized by the input feature size, m, and by the hidden unit size, k. The search is conducted over the hidden unit size, k.

For transformers, the bi-directional encoder representations from transformers (BERT) encoder model may be selected as the backbone architecture for searching. The model comprises projected scaled dot product attention layers and a two layer feedforward network (FFN). Search occurs over the MLP hidden unit size, k, for the attention projection (allowing computing of the dot product in a lower dimension), and the MLP expansion hidden dimension in the FFN. In addition, a special skip operation is included in the search space, which skips the layer and feeds the input directly to the output.

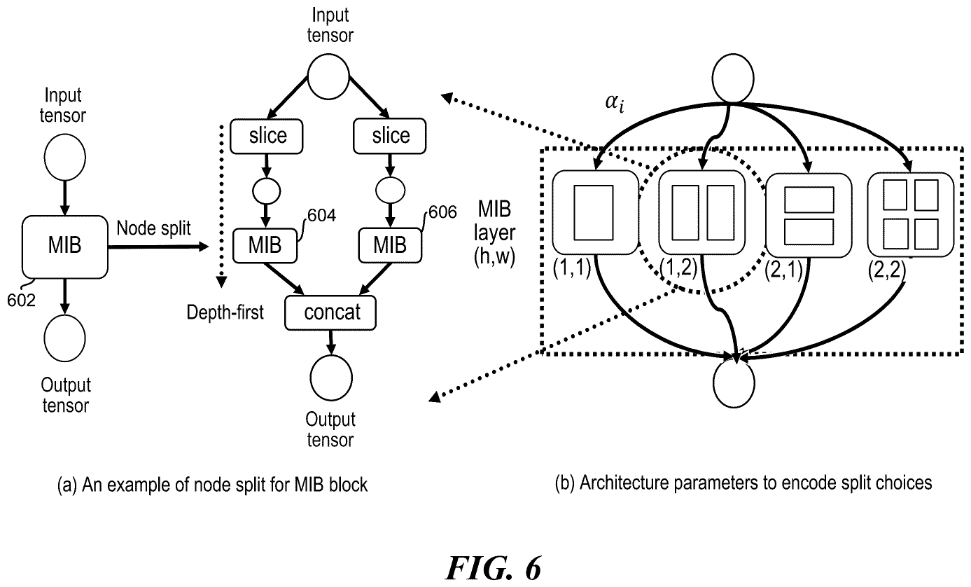

As mentioned above, activation node splitting is introduced. Many convolution networks applied on tasks, such as computer vision tasks, create large intermediate activations. To ensure the peak memory from these activations fits onto a device, convolution node splitting is incorporated into the search space and jointly search with kernel weights. As shown in FIG. 6, the idea is to split each input tensor into multiple smaller tensors.

FIG. 6 is diagram illustrating node splitting with an architecture co-design, in accordance with various aspects of the present disclosure. In the example of FIG. 6, an input tensor 602 may be split into multiple smaller tensors (e.g., nodes 604, 606, see leftmost section (a)). The notation {(h, “w”), h ∈ {1,2, . . . }”, w ∈ “{1,2, . . . }””} denotes the respective number of height and width splits. The split choice may be encoded into the architecture as a path selection problem, as shown in the rightmost section (b). In the solution selected in the example of FIG. 6, the (1,2) choice (corresponding to the architecture parameter α) is selected in which two nodes 604, 606 are side-by-side. The other options (a single node (1,1), sequential nodes (2,1) or four nodes (2,2)) are not selected.

Weight and architecture co-design is now discussed. Aspects of the present disclosure relate to weight sharing mechanisms. Under the defined search space, an over-parameterized super kernel is constructed for each operation in the graph, where different candidates are a subset of the shared weights. The NAS problem simplifies to finding which subset of kernel weights to use in each layer, as shown in FIG. 7.

FIG. 7 is diagram illustrating weight sharing techniques in a super kernel, in accordance with various aspects of the present disclosure. In the example of FIG. 7, a largest super kernel based on the search space is represented as the outer ring 702. Less important weights in the outer ring 702 may be pruned. A middle ring 704 and a center ring 706 correspond to smaller subsets of the outer ring 702. Similarly, in a column-based solution, an outer column 712 corresponds to the largest super kernel and the middle and center columns 714, 716 correspond to smaller subsets of the outer column 712.

Kernels are ring-based for two-dimensional spatial operations, such as convolutions and recurrent kernels. Kernels are column-based for linear projection layers, such as those found in RNN inputs, fully connected layers, or feedforward networks.

As an illustration for the general approach, the case of choosing unit size from {k_1,k_2,k_3} is shown in FIG. 7, in which k_3 represents the largest kernel size, shown in the outer ring 702 in the search space. Taking the gated recurrent unit (GRU) as an example, two super kernels are shown, in the outer ring 702 and outer column 712: the recurrent kernel R and the input kernel W are built for each layer. As shown in FIG. 7, the weights of R_(k_1×k_1) of the middle ring 704 and R_(k_2×k_2) of the center ring 706 can be viewed as the inner parts of the weights of R_(k_3×k_3) the outer ring 702. The outer ring 702 of weights, denoted as R_(k_3×k_3\k_2×k_2), does not contribute to output of the R_(k_2×k_2) of the middle ring 704 but only to the R_(k_3×k_3) of the outer ring 702. Similarly, for column-based kernel sharing, the kernel W for each gate is a m×k_3 matrix, where m is the input feature size. Different from R, weights in W are shared in column-based kernel sharing. The recurrent kernel Rn or input kernel Wn of three gates will be concatenated, respectively, resulting in a recurrent kernel R with the shape of k_3×3·k_3, and an input kernel W with the shape of m×3·k_3. Note, all three gates share the same kernel choice. In the bi-directional RNN case, the forward unit and backward unit are searched separately. For convolutional kernels, weights are extended to be shared in the output channel dimension.

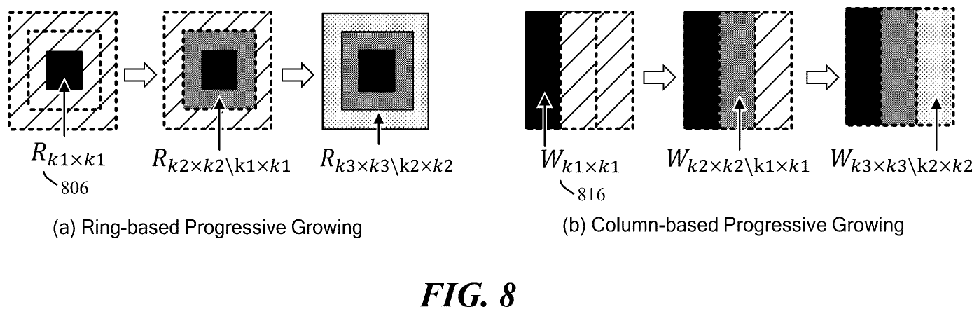

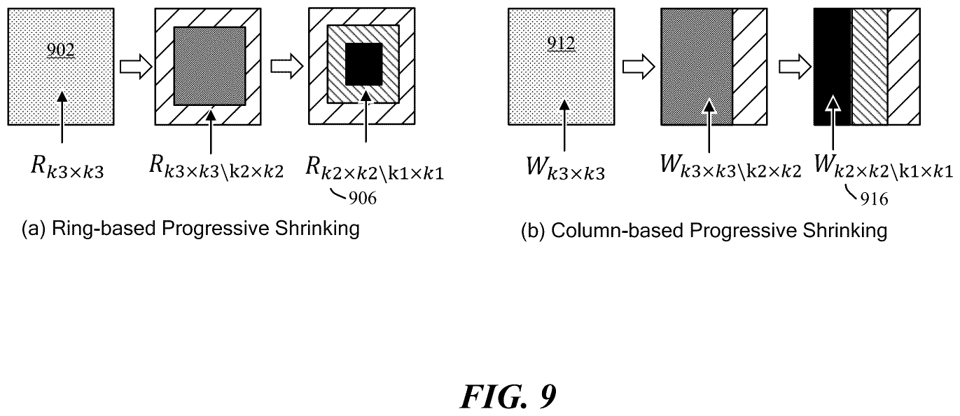

Progressive growing and shrinking will now be discussed with respect to FIGS. 8 and 9. To encode NAS decisions into the super kernels, two separate search strategies are introduced: progressive growing and progressive shrinking.

FIG. 8 is a diagram illustrating progressive growing, in accordance with various aspects of the present disclosure. For progressive growing, the super kernel is defined as:

$${R}_{k} = {{k}_{1}}_{} \cdot {R}_{{k}_{1} \times {k}_{1}} + {{k}_{1}}_{} \cdot {{k}_{2}}_{} \cdot {R}_{{k}_{2} \times {k}_{{2}_{\backslash {k}_{1}}} \times {k}_{1}} + {{k}_{1}}_{} \cdot {{k}_{2}}_{} \cdot {{k}_{3}}_{} \cdot {R}_{{k}_{3} \times {k}_{{3}_{\backslash {k}_{2}}} \times {k}_{2}} , \qquad ( 1 )$$

where [symbol] ₖ_{₁} is the indicator function that encodes the architecture choice of using kernel kᵢ. This indicator is approximated by the sigmoid function in the backward pass for differentiation.

For example, if [symbol] ₖ_{₁}= [symbol] ₖ_{₂}=1 and [symbol] ₖ_{₃}=0, then

$${R}_{k} = {R}_{{k}_{1} \times {k}_{1}} + {R}_{{k}_{2} \times {k}_{{2}_{\backslash {k}_{1}}} \times {k}_{1}} = {R}_{{k}_{2} \times {k}_{2}} ,$$

indicating k₂ has been picked as the kernel size. The selected kernel choice grows from the smallest inner core (e.g., center ring 806 for ring-based progressive growing and left column 816 for column-based progressive growing), outwards. In this case, if [symbol] ₖ_{₂}=0 the kernel stops growing from Rₖ_{₁}_{×k}_{₁}, regardless of the indicator [symbol] ₖ_{₃}.

In contrast, in progressive shrinking, the super kernel is defined as:

$${R}_{k} = {R}_{{k}_{3} \times {k}_{3}} - ( 1 - {𝕀}_{{k}_{3}} ) \cdot {R}_{{k}_{3} \times {k}_{{3}_{\backslash {k}_{2}}} \times {k}_{2}} - ( 1 - {𝕀}_{{k}_{3}} ) \cdot ( 1 - {𝕀}_{{k}_{2}} ) \cdot {R}_{{k}_{2} \times {k}_{{2}_{\backslash {k}_{1}}} \times {k}_{1}} - ( 1 - {𝕀}_{{k}_{3}} ) \cdot ( 1 - {𝕀}_{{k}_{2}} ) \cdot ( 1 - {𝕀}_{{k}_{1}} ) \cdot {R}_{{k}_{1} \times {k}_{1}} . \qquad ( 2 )$$

FIG. 9 is a diagram illustrating progressive shrinking, in accordance with various aspects of the present disclosure. As seen in the example of FIG. 9, the selected kernel choice always shrinks from a largest super kernel 902, 912 to its inner core (e.g., center ring 906 and ring-based progressive shrinking and left column 916 in column-based progressive shrinking). For example, if [symbol] ₖ_{₃}= [symbol] ₖ_{₂}=0 and [symbol] ₖ_{₁}=1, then

$${R}_{k} = {R}_{{k}_{3} \times {k}_{3}} - {R}_{{k}_{3} \times {k}_{{3}_{\backslash {k}_{2}}} \times {k}_{2}} - {R}_{{k}_{2} \times {k}_{{2}_{\backslash {k}_{1}}} \times {k}_{1}} = {R}_{{k}_{1} \times {k}_{1}} ,$$

indicates k₁ has been picked as the kernel choice. If [symbol] ₖ_{₁} further shrinks to 0, Rₖ becomes 0, meaning the operation would be entirely skipped. If the outer ring of the largest super kernel 902 is picked, e.g., [symbol] ₖ_{₃}=1, the kernel stops shrinking from Rₖ_{₃}_{×k}_{₃}, regardless of the inner indicators such as [symbol] ₖ_{₂}.

In general, progressive growing prefers smaller kernel sizes as it only grows when the outer ring becomes important, allowing for faster convergence during search. In contrast, progressive shrinking prefers larger kernel sizes at the initial search stage, as it only shrinks when the outer ring becomes less important, resulting in wider explorations of the search space.

Weight decisions will now be discussed. In the formulation, the indicator function determines the kernel choice. The decision is made by comparing the corresponding norm of the weights with a trainable threshold value t. Take the following as an example:

$${𝕀}_{{k}_{3}} = 𝕀 ( {‖ {R}_{{k}_{3} \times {k}_{{3}_{\backslash {k}_{2}}} \times {k}_{2}} ‖}^{2} > {t}_{k = {k}_{3}} ) , \qquad ( 3 )$$

where the threshold values tₖ₌ₖ₃ is learned during search time to control the kernel decisions. For convolutional neural networks (CNNs), kernels are also shared in the output channel dimension by controlling channel expansion indicators [symbol] ₑ with tₑ, according to Equation 3. In transformer architectures, column-based kernel sharing is used, and the norm of the sub-kernel is further divided by the norm of the super kernel (∥Rₖ_{₃}_{×k}_{₃}∥₂) to accommodate for its large dimension. In RNNs with multiple gates in each layer, such as GRUs, only one decision occurs for each layer with the averaged kernel norm from each gate, as used in Equation 3.

For architecture encodings, the search space is augmented to encode for activation tensor node splits. An architecture parameter α encodes the node split choice for convolutional operations, as shown in the column-based progressive growing of FIG. 8. Let h={1,2, . . . }, w={1,2, . . . } represent the number of splits in each dimension, allowing |h|×|w| paths to be created for each convolution in the super network. Each path is associated with a learnable parameter a_{i,j}, where i ∈ h,j ∈ w. The split choice is formulated as a path selection problem. Let {(i,j):i ∈ h,j ∈ w} be the set of candidate paths, where each stands for a certain split applied on input tensor x. To make the search differentiable, the path choice is relaxed to softmax over all possible splits:

$$o ( x , w ) = {\sum }_{i ∈ h , j ∈ w} \frac{exp ( {a}_{i , j} )}{{\sum }_{{i}^{′} ∈ h , {j}^{′} ∈ w} exp ( {a}_{{i}^{′} , {j}^{′}} )} {o}_{i , j} ( x , w ) , \qquad ( 4 )$$

where o_{i,j}(x,w) represents for the output memory usage from a split of (i,j) in height and width dimensions. At the end of the search, the path with the highest a_{i,j} is selected.

The total memory usage during inference is composed of three parts, a working set buffer fₛ used for input and output activation tensors, metadata fₘ used for graph representation, and persistent memory fₚ for weights storage, as calculated in Equation 5:

$${o}_{i , j} ( x , w ) = {max}_{i , j} {f}_{s} ( x \vert i , j ) + {\sum }_{i , j} {f}_{m} ( i , j ) + {f}_{p} ( w \vert {t}_{k} , {t}_{e} ) . \qquad ( 5 )$$

As CNNs are built on increasing receptive fields, multiple layers of sequential convolution activations may be split by back-propagating the split choice to earlier convolutional blocks to ensure they share the same number of splits, adding overlapping tensor data to each split when required by the receptive field. Although given depth-first scheduling as shown in FIG. 6, the amount of memory required to store intermediate tensors decreases significantly with more splits. The redundant tensor data from ensuring the receptive field remains equivalent, offering a trade-off. Hence, an architecture co-design search may jointly search for parameters and splits.

To search for hardware-efficient networks, model performance of the searched architecture including loss objective, inference latency on target hardware, and peak memory usage are jointly optimized. Hence, the multi-objective loss function is defined as:

l(w|tₖ,a_{i,j})= [symbol] [symbol] lₘₑₘ, (6)

where l_{acc} is the standard loss for a task (e.g., cross-entropy), lₘₛ is the inference latency (in milliseconds) running the model on-device, and lₘₑₘ is defined as the maximum working set memory required to store input and output tensors over all layers, together with the overall metadata and persistent memory. The total runtime latency is further defined as the summation of each layer's runtime across the network.

lₘₛ=Σₗlₘₛ^{l}(tₖ, tₑ, a) ∀i ∈ L, (7)

where tₖ, tₑ are tunable threshold parameters, and a is the architecture parameter as discussed with respect to FIG. 6. Although the overall loss function is described with respect to accuracy, memory, and latency, other hardware resources may also be considered, such as power consumption.

To avoid the pitfall of having to re-profile a model on hardware each time, operations with various configurations in kernel space are pre-profiled with the associated runtime latency and stored in a look-up-table (LUT) (see FIG. 4). The layer runtime for a kernel choice and architecture space can be directly retrieved from the LUT, allowing for fast and accurate metrics.

The network memory loss term in Equation 6, lₘₑₘ, defined as the maximum working set memory required to store input and output tensors over all layers, together with the overall metadata and persistent memory, can be further bounded given a memory budget:

$${l}_{mem}^{′} = {max}_{i ∈ L} {f}_{s}^{l} ( a ) + {\sum }_{l ∈ L} ( {f}_{m}^{l} ( a ) + {f}_{p}^{l} ( {t}_{k} ) ) ∀ l ∈ L \qquad ( 8 )$$

$${l}_{mem} = max \{ {l}_{mem}^{′} - {m}_{budget} , 0 \} \qquad ( 9 )$$

where layer-wise memory usage, parameterized by weight and architecture encodings, is calculated based on Equations 4 and 5, fₛ^{l}(a) corresponds to scratch memory for storing active data, fₘ^{l}(a) corresponds to metadata memory, fₚ^{l}(tₖ) corresponds to persistent memory for storage of activations, and L corresponds to the number of layers in the network.

Loss hyperparameters [symbol] and [symbol] in Equation 6 influence the trade-offs between model accuracy, runtime latency, and the memory usage. For example, larger loss hyperparameter [symbol] values favor more runtime efficiency, leading to smaller model architectures after NAS. In progressive shrinking, this happens by shrinking the model architecture from the largest super kernel to the smallest one. During the search, by minimizing the overall loss, decisions are made to shrink the architecture step by step, converging to the smallest architecture in the search space. This one-shot search trajectory results in a set of model architectures with different model sizes and varied inference latency. Any architecture that fits the hardware requirement is then fully trained in the second stage for better accuracy.

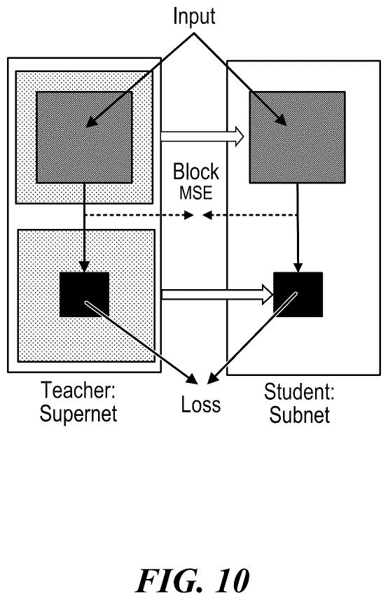

As sub-kernels directly correspond to a super kernel, knowledge distillation (KD) can be applied layer-wise during and after the searching stage. FIG. 10 is a block diagram illustrating knowledge distillation in a neural architecture search (NAS), in accordance with various aspects of the present disclosure. In the example of FIG. 10, an input runs through each layer twice to compute the super kernel and sub-kernel (masked super kernel) activations. In addition to the output loss from the super net (teacher) and the subnet (student), the block-wise mean squared error (MSE) loss between the super net and the subnet contribute to the cross entropy l_{acc} defined in Equation 6:

l_{acc}=l_{acc}^{t}(w)+l_{acc}^{s}(w|tₖ,tₑ)+Σ_{l∈L}lₘₛₑ^{l}(t,s), (10)

where l_{acc}^{t} corresponds to the teacher super net cross entropy and +l_{acc}^{s} corresponds to the student subnet cross entropy.

Techniques of the present disclosure preserve accuracy, while memory and latency are reduced compared to the baseline. Activation node splitting reduces peak memory for tasks, such as image classification, with convolutional networks. Furthermore, the strategies of progressive growing and shrinking allow a search path of models to be discovered, in which one can pick their desired trade-off between latency and memory if both are profiled. On a proxy parameter count metric such as BERT, knowledge distillation leveraging the kernel substructure ensures the searched architectures maintain test loss while being able to outperform a manually compressed baseline.

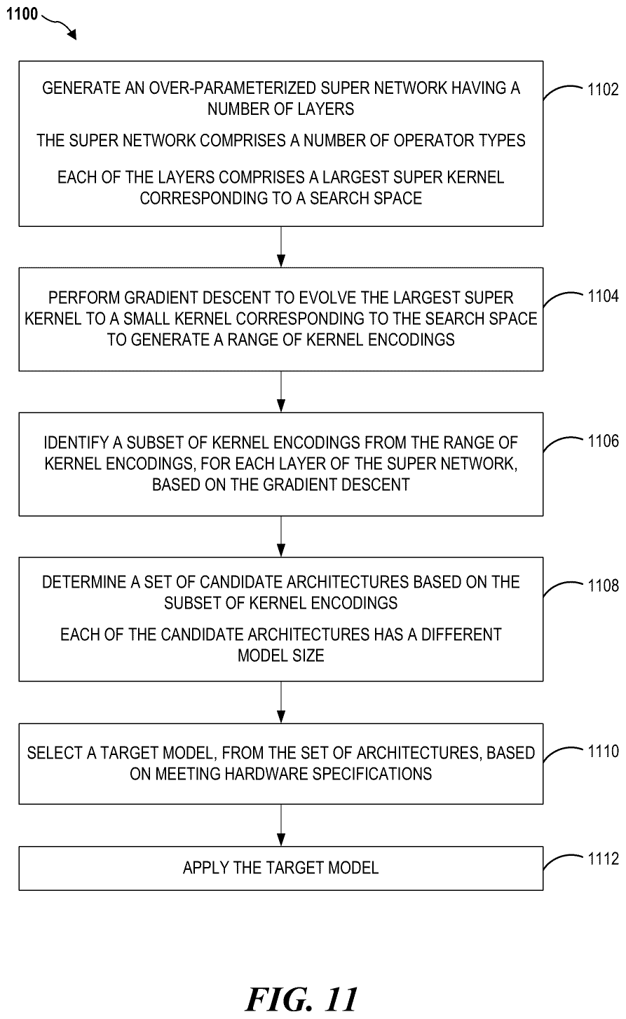

FIG. 11 is a flow diagram illustrating an example processor-implemented method 1100 of searching for a neural network architecture, in accordance with various aspects of the present disclosure. As shown in FIG. 11, in some aspects, the processor-implemented method 1100 may include generating an over-parameterized super network having a number of layers. The super network comprises a number of operator types. Each of the layers comprises a largest super kernel corresponding to a search space (block 1102).

In some aspects, the processor-implemented method 1100 may include performing gradient descent to evolve a largest super kernel to a small kernel corresponding to the search space to generate a range of kernel encodings (block 1104). In some aspects, the processor-implemented method 1100 may include identifying a subset of kernel encodings from the range of kernel encodings, for each layer of the super network, based on the gradient descent (block 1106). In some aspects, the processor-implemented method 1100 may include determining a set of candidate architectures based on the subset of kernel encodings. Each of the candidate architectures has a different model size (block 1108). In some aspects, the processor-implemented method 1100 may include selecting a target model, from the set of architectures, based on meeting hardware specifications (block 1110). In some aspects, the processor-implemented method 400 may include applying the target model (block 1112).

### Example Aspects

Aspect 1: A processor-implemented method, comprising: generating an over-parameterized super network having a plurality of layers, the super network comprising a plurality of operator types, each layer of the plurality of layers comprising a largest super kernel corresponding to a search space; performing gradient descent to evolve a largest super kernel to a small kernel corresponding to the search space to generate a range of kernel encodings; identifying a subset of kernel encodings from the range of kernel encodings, for each layer of the super network, based on the gradient descent; determining a set of candidate architectures based on the subset of kernel encodings, each candidate architecture of the set of candidate architectures having a different model size; selecting a target model, from the set of architectures, based on meeting hardware specifications; and applying the target model.

Aspect 2: The method of Aspect 1, further comprising quantizing the target model.

Aspect 3: The method of Aspect 1 or 2, further comprising splitting convolution node activations of the target model by splitting each input tensor into a plurality of smaller tensors, the plurality of smaller tensors incorporated into the set of candidate architectures.

Aspect 4: The method of any of the preceding Aspects, in which the plurality of operating types comprises at least one convolutional neural network, at least one recurrent neural network, at least one transformer, and at least one multilayer perceptron (MLP).

Aspect 5: The method of any of the preceding Aspects, in which the super network is based on a particular use case, a different super network constructed for each different use case.

Aspect 6: The method of any of the preceding Aspects, in which identifying the subset of kernel encodings comprises progressively increasing a selected kernel choice from a smallest inner core of the largest super kernel to the largest super kernel.

Aspect 7: The method of any of the Aspects 1-5, in which identifying the subset of kernel encodings comprises progressively reducing a selected kernel choice from a largest super kernel to an inner core of the largest super kernel.

Aspect 8: The method of any of the preceding Aspects, in which applying the target model comprises training the target model.

Aspect 9: The method of any of the preceding Aspects, in which the method comprises a one-shot neural architecture search (NAS).

Aspect 10: The method of claim 9, in which the one-shot NAS is based on memory usage of a device that applies the target model, run time latency of the model running on the device, and model accuracy.

Aspect 11: An apparatus, comprising: at least one memory; and at least one processor coupled to the at least one memory, the at least one processor configured to: generate an over-parameterized super network having a plurality of layers, the super network comprising a plurality of operator types, each layer of the plurality of layers comprising a largest super kernel corresponding to a search space; perform gradient descent to evolve the largest super kernel to a small kernel corresponding to the search space to generate a range of kernel encodings; identify a subset of kernel encodings from the range of kernel encodings, for each layer of the super network, based on the gradient descent; determine a set of candidate architectures based on the subset of kernel encodings, each candidate architecture of the set of candidate architectures having a different model size; to select a target model, from the set of architectures, based on meeting hardware specifications; and apply the target model.

Aspect 12: The apparatus of Aspect 11, in which the at least one processor is further configured to quantize the target model.

Aspect 13: The apparatus of Aspect 11 or 12, in which the at least one processor is further configured to split convolution node activations of the target model by splitting each input tensor into a plurality of smaller tensors, the plurality of smaller tensors incorporated into the set of candidate architectures.

Aspect 14: The apparatus of any of the Aspects 11-13, in which the plurality of operating types comprises at least one convolutional neural network, at least one recurrent neural network, at least one transformer, and at least one multilayer perceptron (MLP).

Aspect 15: The apparatus of any of the Aspects 11-14, in which the super network is based on a particular use case, a different super network constructed for each different use case.

Aspect 16: The apparatus of any of the Aspects 11-15, in which the at least one processor is further configured to progressively increase a selected kernel choice from a smallest inner core of the largest super kernel to the largest super kernel.

Aspect 17: The apparatus of any of the Aspects 11-15, in which the at least one processor is further configured to progressively reduce a selected kernel choice from the largest super kernel to an inner core of the largest super kernel.

Aspect 18: The apparatus of any of the Aspects 11-17, in which the at least one processor is further configured to train the target model.

Aspect 19: The apparatus of any of the Aspects 11-18, in which the apparatus is configured to perform a one-shot neural architecture search (NAS).

Aspect 20: The apparatus of any of the Aspects 11-19, in which the one-shot NAS is based on memory usage of a device that applies the target model, run time latency of the model running on the device, and model accuracy.

Aspect 21: An apparatus, comprising: means for generating an over-parameterized super network having a plurality of layers, the super network comprising a plurality of operator types, each layer of the plurality of layers comprising a largest super kernel corresponding to a search space; means for performing gradient descent to evolve the largest super kernel to a small kernel corresponding to the search space to generate a range of kernel encodings; means for identifying a subset of kernel encodings from the range of kernel encodings, for each layer of the super network, based on the gradient descent; means for determining a set of candidate architectures based on the subset of kernel encodings, each candidate architecture of the set of candidate architectures having a different model size; means for selecting a target model, from the set of architectures, based on meeting hardware specifications; and means for applying the target model.

Aspect 22: The apparatus of Aspect 21, further comprising means for quantizing the target model.

Aspect 23: The apparatus of Aspect 21 or 22, further comprising means for splitting convolution node activations of the target model by splitting each input tensor into a plurality of smaller tensors, the plurality of smaller tensors incorporated into the set of candidate architectures.

Aspect 24: The apparatus of any of the Aspects 21-23, in which the plurality of operating types comprises at least one convolutional neural network, at least one recurrent neural network, at least one transformer, and at least one multilayer perceptron (MLP).

Aspect 25: The apparatus of any of the Aspects 21-24, in which the super network is based on a particular use case, a different super network constructed for each different use case.

Aspect 26: The apparatus of any of the Aspects 21-25, in which the means for identifying the subset of kernel encodings comprises means for progressively increasing a selected kernel choice from a smallest inner core of the largest super kernel to the largest super kernel.

Aspect 27: The apparatus of any of the Aspects 21-25, in which the means for identifying the subset of kernel encodings comprises means for progressively reducing a selected kernel choice from the largest super kernel to an inner core of the largest super kernel.

Aspect 28: The apparatus of any of the Aspects 21-27, in which the means for applying the target model comprises means for training the target model.

Aspect 29: The apparatus of any of the Aspects 21-28, in which the apparatus is configured to perform a one-shot neural architecture search (NAS).

Aspect 30: The apparatus of any of the Aspects 21-29, in which the one-shot NAS is based on memory usage of a device that applies the target model, run time latency of the model running on the device, and model accuracy.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database, or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer- readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A processor-implemented method, comprising:
generating an over-parameterized super network having a plurality of layers, the super network comprising a plurality of operator types, each layer of the plurality of layers comprising a largest super kernel corresponding to a search space;
performing gradient descent to evolve the largest super kernel to a small kernel corresponding to the search space to generate a range of kernel encodings;
identifying a subset of kernel encodings from the range of kernel encodings, for each layer of the super network, based on the gradient descent;
determining a set of candidate architectures based on the subset of kernel encodings, each candidate architecture of the set of candidate architectures having a different model size;
selecting a target model, from the set of architectures, based on meeting hardware specifications; and
applying the target model.

2. The method of claim 1, further comprising quantizing the target model.

3. The method of claim 1, further comprising splitting convolution node activations of the target model by splitting each input tensor into a plurality of smaller tensors, the plurality of smaller tensors incorporated into the set of candidate architectures.

4. The method of claim 1, in which the plurality of operating types comprises at least one convolutional neural network, at least one recurrent neural network, at least one transformer, and/or at least one multilayer perceptron (MLP).

5. The method of claim 1, in which the super network is based on a particular use case, a different super network constructed for each different use case.

6. The method of claim 1, in which identifying the subset of kernel encodings comprises progressively increasing a selected kernel choice from a smallest inner core of the largest super kernel to the largest super kernel.

7. The method of claim 1, in which identifying the subset of kernel encodings comprises progressively reducing a selected kernel choice from the largest super kernel to an inner core of the largest super kernel.

8. The method of claim 1, in which applying the target model comprises training the target model.

9. The method of claim 1, in which the method comprises a one-shot neural architecture search (NAS).

10. The method of claim 9, in which the one-shot NAS is based on at least one of: memory usage of a device that applies the target model, run time latency of the model running on the device, a model accuracy, and power consumption of the device.

11. An apparatus, comprising:
at least one memory; and
at least one processor coupled to the at least one memory, the at least one processor configured to:
generate an over-parameterized super network having a plurality of layers, the super network comprising a plurality of operator types, each layer of the plurality of layers comprising a largest super kernel corresponding to a search space;
perform gradient descent to evolve the largest super kernel to a small kernel corresponding to the search space to generate a range of kernel encodings;
identify a subset of kernel encodings from the range of kernel encodings, for each layer of the super network, based on the gradient descent;
determine a set of candidate architectures based on the subset of kernel encodings, each candidate architecture of the set of candidate architectures having a different model size;
select a target model, from the set of architectures, based on meeting hardware specifications; and
apply the target model.

12. The apparatus of claim 11, in which the at least one processor is further configured to quantize the target model.

13. The apparatus of claim 11, in which the at least one processor is further configured to split convolution node activations of the target model by splitting each input tensor into a plurality of smaller tensors, the plurality of smaller tensors incorporated into the set of candidate architectures.

14. The apparatus of claim 11, in which the plurality of operating types comprises at least one convolutional neural network, at least one recurrent neural network, at least one transformer, and/or at least one multilayer perceptron (MLP).

15. The apparatus of claim 11, in which the super network is based on a particular use case, a different super network constructed for each different use case.

16. The apparatus of claim 11, in which the at least one processor is further configured to progressively increase a selected kernel choice from a smallest inner core of the largest super kernel to the largest super kernel.

17. The apparatus of claim 11, in which the at least one processor is further configured to progressively reduce a selected kernel choice from the largest super kernel to an inner core of the largest super kernel.

18. The apparatus of claim 11, in which the at least one processor is further configured to train the target model.

19. The apparatus of claim 11, in which the apparatus is configured to perform a one-shot neural architecture search (NAS).

20. The apparatus of claim 19, in which the one-shot NAS is based on at least one of: memory usage of a device that applies the target model, run time latency of the model running on the device, a model accuracy, and power consumption of the device.

21. An apparatus, comprising:
means for generating an over-parameterized super network having a plurality of layers, the super network comprising a plurality of operator types, each layer of the plurality of layers comprising a largest super kernel corresponding to a search space;
means for performing gradient descent to evolve the largest super kernel to a small kernel corresponding to the search space to generate a range of kernel encodings;
means for identifying a subset of kernel encodings from the range of kernel encodings, for each layer of the super network, based on the gradient descent;
means for determining a set of candidate architectures based on the subset of kernel encodings, each candidate architecture of the set of candidate architectures having a different model size;
means for selecting a target model, from the set of architectures, based on meeting hardware specifications; and
means for applying the target model.

22. The apparatus of claim 21, further comprising means for quantizing the target model.

23. The apparatus of claim 21, further comprising means for splitting convolution node activations of the target model by splitting each input tensor into a plurality of smaller tensors, the plurality of smaller tensors incorporated into the set of candidate architectures.

24. The apparatus of claim 21, in which the plurality of operating types comprises at least one convolutional neural network, at least one recurrent neural network, at least one transformer, and/or at least one multilayer perceptron (MLP).

25. The apparatus of claim 21, in which the super network is based on a particular use case, a different super network constructed for each different use case.

26. The apparatus of claim 21, in which the means for identifying the subset of kernel encodings comprises means for progressively increasing a selected kernel choice from a smallest inner core of the largest super kernel to the largest super kernel.

27. The apparatus of claim 21, in which the means for identifying the subset of kernel encodings comprises means for progressively reducing a selected kernel choice from the largest super kernel to an inner core of the largest super kernel.

28. The apparatus of claim 21, in which the means for applying the target model comprises means for training the target model.

29. The apparatus of claim 21, in which the apparatus is configured to perform a one-shot neural architecture search (NAS).

30. The apparatus of claim 29, in which the one-shot NAS is based on at least one of: memory usage of a device that applies the target model, run time latency of the model running on the device, a model accuracy, and power consumption of the device.
